(19) United States
(12) Patent Application Publication
(10) Pub. No.: US 2025/0139642 A1
(43) Pub. Date: May 1, 2025

(54) SYSTEM AND METHOD FOR REGULATORY COMPLIANCE MANAGEMENT

(71) Applicant: JPMorgan Chase Bank, N.A., New York, NY (US)

(72) Inventors: Ranjit RADHAKRISHNAN, Mumbai (IN); Sidharth TALWAR, Greater Noida (IN); Sanjay Saran GARG, Bangalore (IN)

(73) Assignee: JPMorgan Chase Bank, N.A., New York, NY (US)

(21) Appl. No.: 18/924,634

(22) Filed: Oct. 23, 2024

(30) Foreign Application Priority Data
Nov. 1, 2023 (IN) 202311074482

(51) Int. Cl. G06Q 30/018

(52) U.S. Cl. CPC G06Q 30/018

(57) ABSTRACT

A system and method for regulatory compliance management are disclosed. The method includes receiving, by the at least one processor, at least one regulatory document from at least one regulatory source. Further, the method includes analyzing, by the at least one processor using a trained model, the at least one regulatory document. Further, the method includes drafting, by the at least one processor, an obligation for at least one entity based on the analysis of the at least one regulatory document. Further, the method includes mapping, by the at least one processor, an information in the obligation to at least one of a set of internal procedures and policies of the at least one entity. Further, the method includes updating, by the at least one processor, the internal procedures and policies of the at least one entity to maintain a legal compliance with the obligation.

### CROSS-REFERENCE TO RELATED APPLICATIONS

This application claims priority benefit from Indian Application No. 202311074482, filed on Nov. 1, 2023 in the India Patent Office, which is hereby incorporated by reference in its entirety.

### FIELD OF THE DISCLOSURE

This technology generally relates to regulatory compliance. Moreover, the present disclosure relates to a method and a system for regulatory compliance management based on an artificial intelligence (AI) based trained model.

### BACKGROUND INFORMATION

The following description of the related art is intended to provide background information pertaining to the field of the present disclosure. This section may include certain aspects of the art that may be related to various features of the present disclosure. However, it should be appreciated that this section is used only to enhance the understanding of the reader with respect to the present disclosure, and not as admission of the prior art.

As is commonly understood, regulatory changes occur frequently and are often complex, in various domains such as the financial sector. These changes arise due to various factors, including concerns related to privacy, transparency, security, the environment, and the like. Considering frequent development and changes in rules and regulations, organizations are required to stay updated and ensure compliance with regulatory policies and industry standards for their products and services. The current process involves several steps and requires manual efforts for monitoring regulatory changes, drafting obligations, preparing action plans, and updating procedures and policies. This manual approach leads to inefficiencies, inaccuracies, increased research expenses, prolonged compliance timelines, and the like.

Hence, in view of these and other existing limitations, there arises an imperative need to provide an efficient solution to overcome the above-mentioned limitations and to provide a method and system that would not only ensure compliance with the regulations but also make it more accessible, accurate, and adaptive to enhance operation efficiency.

### SUMMARY

The present disclosure, through one or more of its various aspects, embodiments, and/or specific features or sub-components, provides, inter alia, various systems, servers, devices, methods, media, programs, and platforms for optimized regulatory compliance management.

According to an aspect of the present disclosure, a method for regulatory compliance management is disclosed. The method is implemented by at least one processor. The method includes receiving, by the at least one processor, at least one regulatory document from at least one regulatory source. Next, the method includes analyzing, by the at least one processor using a trained model, the at least one regulatory document. Next, the method includes drafting, by the at least one processor, an obligation for at least one entity based on a result of the analyzing of the at least one regulatory document. Next, the method includes automatically mapping, by the at least one processor, an information in the obligation to at least one from among a plurality of internal procedures and policies of the at least one entity. Next, the method includes updating, by the at least one processor, the plurality of internal procedures and policies of the at least one entity to maintain a legal compliance with the obligation.

In accordance with an exemplary embodiment, the at least one regulatory document includes a notification regarding at least one from among: a change in at least one from among a law, a rule, and a regulation; and a creation of at least one from among a new law, a new rule, and a new regulation.

In accordance with an exemplary embodiment, the trained model includes a large language model, which is trained using each of a set of legal data collected from a plurality of legal sources, and a set of procedural data collected from a plurality of procedural sources.

In accordance with an exemplary embodiment, the mapping of the information in the obligation to the at least one from among the plurality of internal procedures and policies includes identifying, by the at least one processor, at least one from among a plurality of impacted lines of business (LOB) and at least one from among a plurality of associated teams; and mapping, by the at least one processor, the plurality of internal procedures and policies of the identified at least one impacted LOB with the obligation.

In accordance with an exemplary embodiment, the method further includes creating, by the at least one processor, at least one action plan for the at least one entity to resolve at least one control issue identified during the mapping of the information in the obligation to the at least one from among the plurality of internal procedures and policies, wherein the at least one action plan corresponds to at least one change to be performed to update the plurality of internal procedures and policies of the at least one entity to maintain the legal compliance with the obligation.

In accordance with an exemplary embodiment, the at least one entity corresponds to one from among an organization, a financial institution, a business entity, a firm, and a service provider.

In accordance with an exemplary embodiment, updating the plurality of internal procedures and policies to maintain the legal compliance with the obligation includes one from among: a modification of the plurality of internal procedures and policies; and an addition of at least one from among a new procedure and a new policy.

According to another aspect of the present disclosure, a computing device configured to implement an execution of a method for regulatory compliance management is disclosed. The computing device includes a processor; a memory; and a communication interface coupled to each of the processor and the memory. The processor may be configured to receive at least one regulatory document from at least one regulatory source. Next, the processor may be configured to analyze, using a trained model, the at least one regulatory document. Next, the processor may be configured to draft an obligation for at least one entity based on the analysis of the at least one regulatory document. Next, the processor may be configured to map an information in the obligation to at least one from among a plurality of internal procedures and policies of the at least one entity. Next, the processor may be configured to update the plurality of internal procedures and policies of the at least one entity to maintain a legal compliance with the obligation.

In accordance with an exemplary embodiment, the at least one regulatory document includes a notification regarding at least one from among: a change in a law, a rule, and a regulation; and a creation of at least one from among a new law, a new rule, and a new regulation.

In accordance with an exemplary embodiment, the trained model includes a large language model, which is trained using each of a set of legal data collected from a plurality of legal sources, and a set of procedural data collected from a plurality of procedural sources.

In accordance with an exemplary embodiment, to map the information in the obligation to the at least one from among the plurality of internal procedures and policies, the processor is configured to identify at least one from among a plurality of impacted LOB and at least one from among a plurality of associated teams; and map the plurality of internal procedures and policies of the identified at least one impacted LOB with the obligation.

In accordance with an exemplary embodiment, the processor is further configured to create at least one action plan for the at least one entity to resolve at least one control issue identified during the mapping of the information in the obligation to the at least one from among the plurality of internal procedures and policies, wherein the at least one action plan corresponds to at least one change to be performed to update the plurality of internal procedures and policies of the at least one entity to maintain the legal compliance with the obligation.

In accordance with an exemplary embodiment, the at least one entity corresponds to one from among an organization, a financial institution, a business entity, a firm, and a service provider.

In accordance with an exemplary embodiment, the update of the plurality of internal procedures and policies to maintain the legal compliance with the obligation includes one from among: a modification of the plurality of internal procedures and policies; and an addition of at least one from among a new procedure and a new policy.

According to yet another aspect of the present disclosure, a non-transitory computer-readable storage medium storing instructions for regulatory compliance management is disclosed. The instructions include executable code which, when executed by a processor, may cause the processor to receive at least one regulatory document from at least one regulatory source; analyze, using a trained model, the at least one regulatory document; draft an obligation for at least one entity based on the analysis of the at least one regulatory document; map an information in the obligation to at least one from among a plurality of internal procedures and policies of the at least one entity; and update the plurality of internal procedures and policies of the at least one entity to maintain a legal compliance with the obligation.

In accordance with an exemplary embodiment, the at least one regulatory document includes a notification regarding at least one from among: a change in at least one from among a law, a rule, and a regulation; and a creation of at least one from among a new law, a new rule, and a new regulation.

In accordance with an exemplary embodiment, the trained model includes a large language model, which is trained using each of a set of legal data collected from a plurality of legal sources and a set of procedural data collected from a plurality of procedural sources.

In accordance with an exemplary embodiment, to map the information in the obligation to the at least one from among the plurality of internal procedures and policies, the executable code when executed causes the processor to identify at least one from among a plurality of impacted LOB and at least one from among a plurality of associated teams; and map the plurality of internal procedures and policies of the identified at least one impacted LOB with the obligation.

In accordance with an exemplary embodiment, the executable code when executed causes the processor to create at least one action plan for the at least one entity to resolve at least one control issue identified during the mapping of the information in the obligation to the at least one from among the plurality of internal procedures and policies, wherein the at least one action plan corresponds to at least one change to be performed to update the plurality of internal procedures and policies of the at least one entity to maintain the legal compliance with the obligation.

In accordance with an exemplary embodiment, the at least one entity corresponds to one from among an organization, a financial institution, a business entity, a firm, and a service provider.

In accordance with an exemplary embodiment, the update of the plurality of internal procedures and policies to maintain the legal compliance with the obligation includes one from among: a modification of the plurality of internal procedures and policies; and an addition of at least one from among a new procedure and a new policy.

### BRIEF DESCRIPTION OF THE DRAWINGS

The present disclosure is further described in the detailed description which follows, in reference to the noted plurality of drawings, by way of non-limiting examples of exemplary embodiments of the present disclosure, in which like characters represent like elements throughout the several views of the drawings.

FIG. 1 illustrates an exemplary computer system for regulatory compliance management in accordance with an exemplary embodiment of the present disclosure.

FIG. 2 illustrates an exemplary diagram of a network environment for regulatory compliance management in accordance with an exemplary embodiment of the present disclosure.

FIG. 3 illustrates an exemplary system for regulatory compliance management in accordance with an exemplary embodiment of the present disclosure.

FIG. 4 illustrates an exemplary method flow diagram for regulatory compliance management in accordance with an exemplary embodiment of the present disclosure.

FIG. 5 illustrates a process flow diagram usable for regulatory compliance management in accordance with an exemplary embodiment of the present disclosure.

FIG. 6 illustrates a process flow diagram usable for regulatory compliance operations in accordance with an exemplary embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

To overcome the problems associated with the compliance of financial institutions with the regulatory changes, the present disclosure provides a method and system for efficient management of regulatory compliance.

The system facilitates obligation drafting and compliance planning that is more accurate, efficient, and reliable. The system first receives at least one regulatory document from at least one regulatory source. The regulatory document may correspond to a notification of an external legal or regulatory development, e.g., a change in a law, a rule, a regulation, or creation of a new law, a new rule, or a new regulation. In an exemplary implementation, the at least one regulatory source may include, but is not limited to, a website, app, page, link, newspaper, or official gazette. In an example, a financial regulatory authority introduces a new rule that lowers the penalty rate that credit card companies may charge on late payment of dues. The financial regulatory may update this new rule on the official website. Thus, the new rule corresponds to a regulatory change in the financial domain, and the official website that displays the new rule corresponds to the source of the regulatory change or regulatory document. Next, the system analyzes, using a trained model, the at least one regulatory document. The at least one regulatory document is analyzed using a trained model. As used herein, the trained model corresponds to a large language model, which is trained using a set of legal data collected from a plurality of legal sources and a set of procedural data collected from a plurality of procedural sources. The plurality of legal sources includes, but are not limited to, lawbooks, federal and state law websites, judicial websites, financial news platforms, and the like. The plurality of procedural sources includes a database of an organization (e.g., financial institution), procedure library, website of the organization, published articles, blogs, and the like.

The system then analyzes, using a trained model, the at least one regulatory document to extract the key information from the regulatory document. The system analyzes the regulatory documents based on the training on various legal datasets. Next, the system drafts an obligation for at least one entity based on the analysis of the at least one regulatory document. In a non-limiting embodiment, the at least one entity corresponds to one from among an organization, a financial institution, a business entity, a firm, or a service provider. With reference to the present disclosure, the at least one entity may correspond to a commercial bank (CB). As used herein, the commercial bank refers to a financial institution that provides financial-related services like loans, deposits, bank accounts, and the like. Next, the system assesses and identifies the impacted line of business (LOB) and the corresponding impacted team. Next, the system maps an information in the obligation to the internal procedures and policies of the impacted LOB associated with the at least one entity. In an exemplary implementation, amendments in bank security policy may impact the security team and their corresponding tasks or services.

The system is further configured to create at least one action plan for the at least one entity to resolve at least one control issue identified during the mapping of the information in the obligation to the internal procedures and policies. The at least one action plan corresponds to at least one change to be performed to update the internal procedures and policies associated with the at least one entity to maintain legal compliance with the obligation. Thus, the at least one action plan facilitates updating the procedures and policies of the at least one entity. Next, the system updates the internal procedures and policies of the at least one entity to maintain legal compliance with the obligation. In an exemplary embodiment, updating the internal procedures and policies includes one of: modification of the internal procedures and policies; or the addition of new procedures and policies.

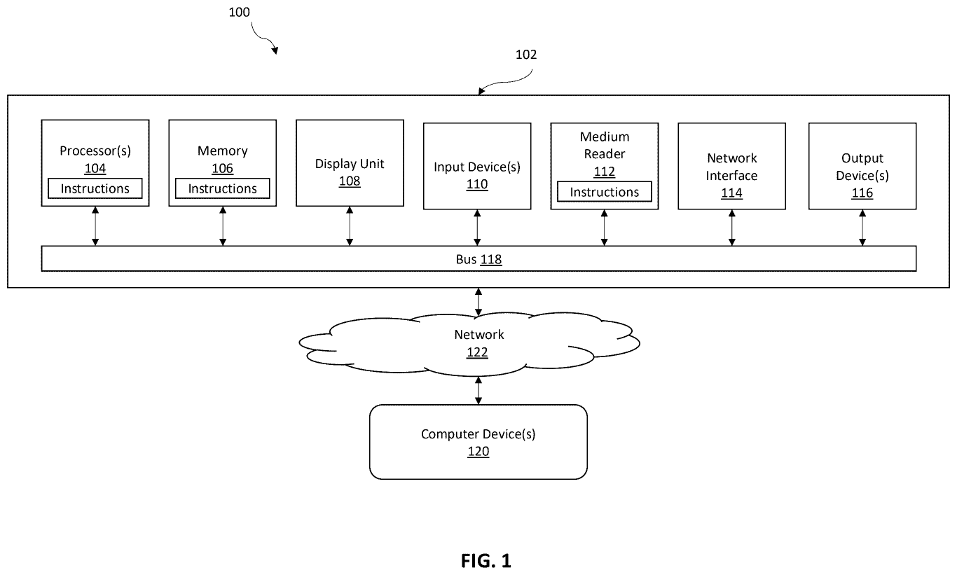

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud-based environment. Even further, the instructions may be operative in such a cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. Processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a Display Unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for regulatory compliance management.

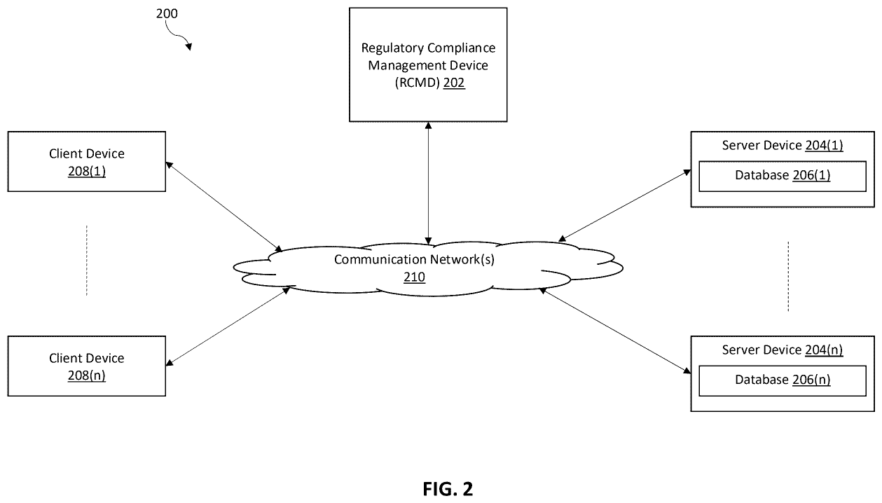

Referring to FIG. 2, a schematic of an exemplary network environment 200 for implementing a method for regulatory compliance management is illustrated. In an exemplary embodiment, the method is executable on any networked computer platform, such as, for example, a personal computer (PC).

The method for efficient regulatory compliance of procedures and policies associated with a financial institution may be implemented by a regulatory compliance management device (RCMD) 202. The RCMD 202 may be the same or similar to the computer system 102 as described with respect to FIG. 1. The RCMD 202 may store one or more applications that can include executable instructions that, when executed by the RCMD 202, cause the RCMD 202 to perform desired actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the RCMD 202 itself, may be located in the virtual server(s) running in a cloud-based computing environment rather than being tied to one or more specific physical network computing devices. Also, the application(s) may be running in one or more virtual machines (VMs) executing on the RCMD 202. Additionally, in one or more embodiments of this technology, virtual machine(s) running on the RCMD 202 may be managed or supervised by a hypervisor.

In the network environment 200 of FIG. 2, the RCMD 202 is coupled to a plurality of server devices 204(1)-204(n) that hosts a plurality of databases 206(1)-206(n), and also to a plurality of client devices 208(1)-208(n) via communication network(s) 210. A communication interface of the RCMD 202, such as the network interface 114 of the computer system 102 of FIG. 1, operatively couples and communicates between the RCMD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the RCMD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and RCMDs that efficiently implement the method of regulatory compliance management.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), Ethernet-based packet data networks (PDNs), combinations thereof, and the like.

The RCMD 202 may be a standalone device or integrated with one or more other devices or apparatuses, such as one or more of the server devices 204(1)-204(n), for example. In one particular example, the RCMD 202 may include or be hosted by one of the server devices 204(1)-204(n), and other arrangements are also possible. Moreover, one or more of the devices of the RCMD 202 may be in a same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the RCMD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store data related to law and regulatory feeds, updated procedures, and policies of an organization.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the RCMD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the RCMD 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the RCMD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the RCMD 202, the server devices 204(1)-204(n), or the client devices 208(1)-208(n), for example, may be configured to operate as virtual instances on the same physical machine. In other words, one or more of the RCMDs 202, the server devices 204(1)-204(n), or the client devices 208(1)-208(n) may operate on the same physical device rather than as separate devices communicating through communication network(s) 210. Additionally, there may be more or fewer RCMDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

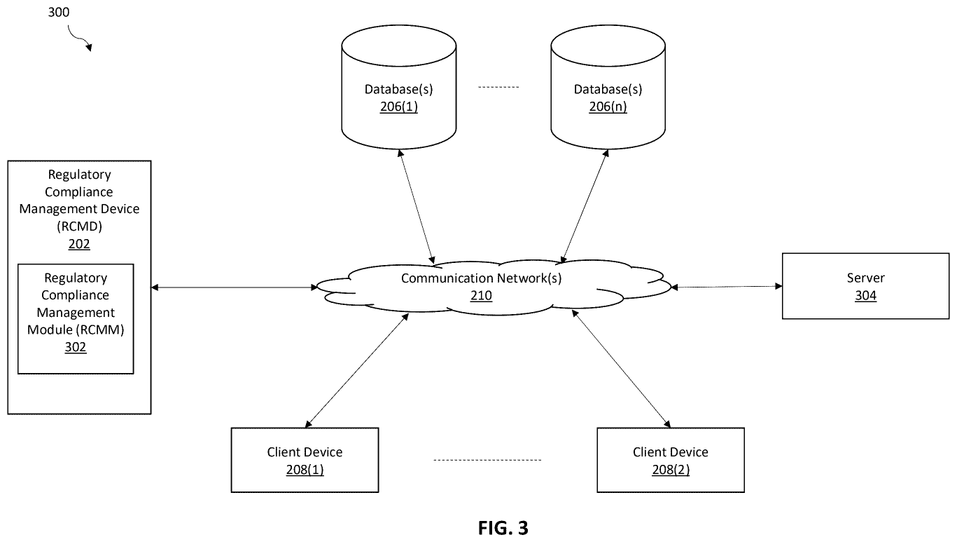

FIG. 3 illustrates an exemplary system for implementing a method for regulatory compliance management in accordance with an exemplary embodiment.

As illustrated in FIG. 3, the system 300 may include a regulatory compliance management device (RCMD) 202 within which a regulatory compliance management module (RCMM) 302 is embedded, a server 304, a database(s) 206(1) . . . 206(n), a plurality of client devices 208(1) . . . 208(2), and a communication network(s) 210.

According to exemplary embodiments, the RCMD 202 including the RCMM 302 may be connected to the server 304, and the database(s) 206(1) . . . 206(n) via the communication network(s) 210, but the disclosure is not limited thereto. The RCMD 202 may also be connected to the plurality of client devices 208(1) . . . 208(2) via the communication network 210, but the disclosure is not limited thereto. The database(s) 206(1) . . . 206(n) may include rule database.

In an embodiment, the RCMD 202 is described and shown in FIG. 3 as including the RCMM 302, although it may include other rules, policies, modules, databases, or applications, for example. As will be described below, the RCMM 302 is configured to implement a method for regulatory compliance management.

An exemplary system 300 for implementing a mechanism for regulatory compliance management by utilizing the network environment of FIG. 2 is shown as being executed in FIG. 3. Specifically, a first client device 208(1) and a second client device 208(2) are illustrated as being in communication with the RCMD 202. In this regard, the first client device 208(1) and the second client device 208(2) may be “clients” of the RCMD 202 and are described herein as such. Nevertheless, it is to be known and understood that the first client device 208(1) and/or the second client device 208(2) need not necessarily be “clients” of the RCMD 202, or any entity described in association therewith herein. Any additional or alternative relationship may exist between either or both of the first client device 208(1) and the second client device 208(2) and the RCMD 202, or no relationship may exist.

Further, the RCMD 202 is illustrated as being able to access one or more databases 206(1) . . . 206(n). The RCMM 302 may be configured to access these repositories/databases for implementing a method for regulatory compliance management. In some embodiment, the server 304 may be the same or equivalent to the server device 204 as illustrated in FIG. 2. The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the RCMD 202 via broadband or cellular communication. These embodiments are merely exemplary and are not limiting or exhaustive.

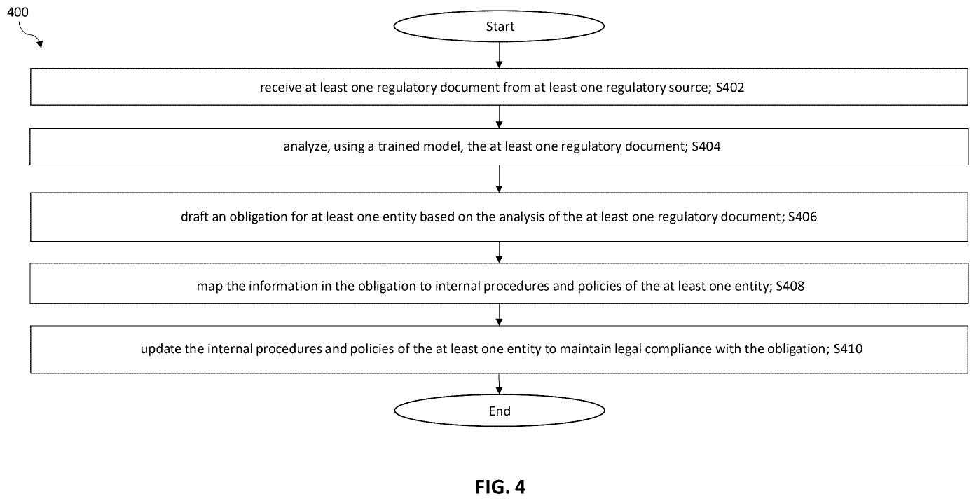

Referring to FIG. 4, an exemplary method 400 is shown for regulatory compliance management in accordance with an exemplary embodiment. As shown in FIG. 4, the method begins following a need for compliance of at least one entity with various obligation and regulation requirements, further involving an optimized and efficient way to comply with the requirements of the regulations.

At step S402, the method includes receiving, by the at least one processor, at least one regulatory document from at least one regulatory source. The regulatory document may correspond to a notification of an external legal or regulatory development, e.g., a change in a law, a rule, or a regulation or the creation of a new law, a new rule, or a new regulation. In an implementation, the existing rule associated with a financial sector may be changed or updated based on a joint meeting of various regulatory entities. In another implementation, a new rule may be created by the regulatory entities that need to be complied with by the financial banks and institutions. In an exemplary implementation, the at least one regulatory source may include, but is not limited to, a website, app, page, link, newspaper, official gazette, judicial platforms, and news platforms. In an implementation, a central and regulatory bank may upload a notification regarding a change in loan rules on the website associated with the central bank.

At step S404, the method includes analyzing, by the at least one processor using a trained model, the at least one regulatory document. The trained model is a large language model (LLM), which is trained using a set of legal data collected from a plurality of legal sources and a set of procedural data collected from a plurality of procedural sources. In an exemplary implementation, the plurality of legal sources includes but is not limited to, lawbooks, federal and state law websites, judicial websites, financial news platforms, and the like. In an exemplary implementation, the plurality of procedural sources includes a database of a financial organization or institution, users or teams associated with the financial organization, websites of the financial organization, procedure library of the financial organization, and the like.

In a non-limiting implementation, the trained model, which corresponds to LLM, is a type of an artificial intelligence (AI) model that is designed to understand and generate human-like text based on the patterns and information it has learned from vast amounts of text data. LLMs are a subfield of natural language processing (NLP) and are typically built using deep learning techniques.

At step S406, the method includes drafting, by the at least one processor, an obligation for at least one entity based on the analysis of the at least one regulatory document. As used herein, an obligation is a legal requirement impacting the at least one entity's businesses or functions. The obligation summarizes the requirement(s) with which the at least one entity must comply and describes what the at least one entity must do or must not do to comply with the identified legal requirement(s). In a non-limiting implementation, the at least one entity corresponds to one from among an organization, a financial institution, a business entity, a firm, or a service provider. In an example, a commercial bank A is considered an entity that needs to comply with the obligations and regulations set by the regulatory authority.

At step S408, the method includes mapping, by the at least one processor, the information in the obligation to internal procedures and policies of the at least one entity. The mapping of the information in the obligation to the corresponding internal procedures and policies includes identifying, by the at least one processor, one or more impacted lines of business (LOB) and one or more associated teams. Based on the identification of the impacted LOB and associated team, the method includes the step of mapping, by the at least one processor, the internal procedures and policies of the identified impacted LOB with the obligation. In an example, obligation requires a bank to verify the property of the loan seeker before providing any loan. Here, the impacted lines of business correspond to a loan sector or loan services and the associated team corresponds to a loan department or loan management team.

The method further includes creating, by the at least one processor, at least one action plan for the at least one entity to resolve at least one control issue identified during the mapping of the information in the obligation to the internal procedures and policies. The control issue corresponds to at least one issue that needs to be controlled to comply with the obligation requirements. The at least one action plan corresponds to at least one change to be performed to update the internal procedures and policies associated with the at least one entity to maintain legal compliance with the obligation. In an exemplary implementation of the present disclosure, particular lines or paragraphs in the existing procedures and policies are identified that need to be changed to comply with the obligation requirements.

In an example, the action plan may include adding the step of verification of the property of the loan seeker in the existing procedure and policy of the banks. In an exemplary implementation, the at least one action plan may also include training of the relevant team, expense planning, spreading awareness on the regulatory requirements, and the like.

At step S410, the method includes updating, by the at least one processor, the internal procedures and policies of the at least one entity to maintain legal compliance with the obligation. Updating the internal procedures and policies may be performed based on the creation of at least one action plan. in an embodiment, the updating of the internal procedures and policies to meet legal requirements of the obligation may include at least one of: modification of the internal procedures and policies; and/or the addition of new procedures and policies. The modification of the internal procedures and policies corresponds to an update in the existing rules and regulations based on a change in the rules. The addition of new procedures and policies corresponds to the addition of new rules and regulations in the absence of any existing rules and procedures of the bank.

In an example, the central bank regulates a notice on amendments in the loan sanction rules. As per the amendments, an additional verification step is added to the loan sanction process. The system, using the trained model, drafts an obligation based on the amended rule and then identifies the impacted LOB and team. Next, the system compares or maps the amended rule with the existing procedures and policies of the financial banks. Based on the mapping, the system determines that the existing procedure does not include the additional verification step in the policy and procedures. Therefore, the system creates an action plan to update the existing internal procedures by adding the new verification step in policies associated with the loan sanction process.

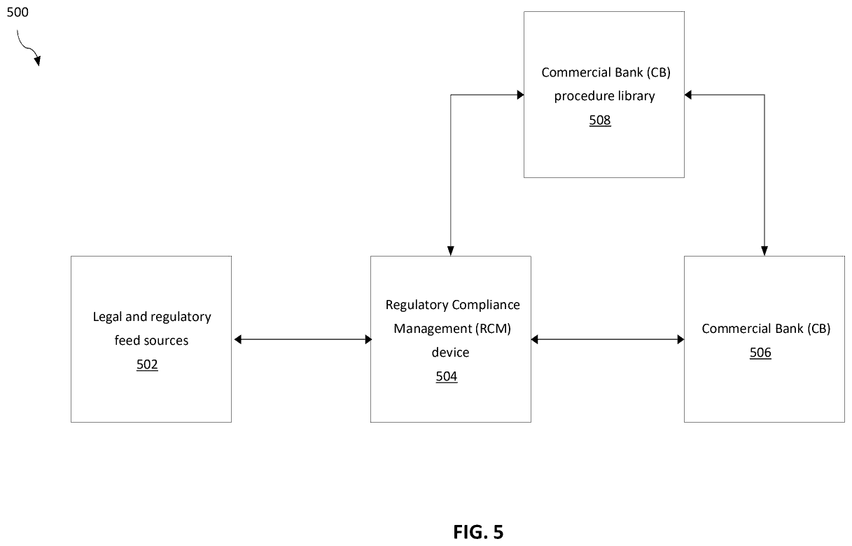

FIG. 5 illustrates a process flow diagram usable for regulatory compliance management, in accordance with an exemplary implementation. As illustrated in FIG. 5, the process flow 500 begins with receiving, by a regulatory compliance management device (RCMD) 504, a legal and regulatory feed from legal and regulatory feed sources 502. The legal and regulatory feed may include any update or change in the rules associated with the commercial banks. The RCMD 504 fetches procedures and policies-related data of a commercial bank (CB) 506 from a CB procedure library 508. The RCMD 504 then drafts an obligation for the commercial bank based on the legal and regulatory feed. The RCMD 504 then identifies the impacted line of business (LOB) of the CB 506 and matches at least one procedure of the impacted LOB from CB procedures library 508 to obligation. Based on the matching, the RCMD 504 draft control issues and action plans to resolve document discrepancies. Accordingly, the RCMD 504 updates procedures and policies in the CB procedure library 508. More particularly, the RCMD 504 performs document uplift and document discrepancy remediation for the creation of new procedures or modification of existing procedures to show compliance with the legal requirements of the obligation.

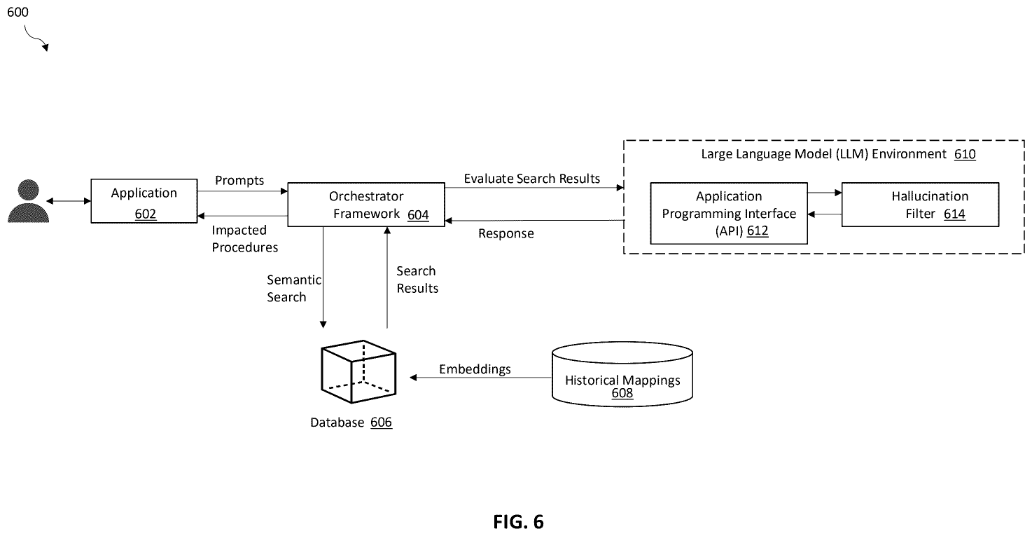

FIG. 6 illustrates a process flow diagram usable for regulatory compliance operations in accordance with an exemplary implementation. As illustrated in FIG. 6, the process flow 600 begins with receiving, by an application 602 (also referred to as legal compliance and regulatory assessment tool), a legal and regulatory feed from legal and regulatory feed sources. The legal and regulatory feed sources may include but are not limited to, a website, app, page, link, newspaper, official gazette, judicial platforms, and news platforms. In an exemplary implementation, the application 602 is communicably coupled with a procedure library and an obligation library of a firm or a bank. The procedure library may include existing procedures to ensure compliance with legal requirements of various obligations. The obligation library may include existing obligations in relation to the firm or new obligation(s). As used herein, the term procedure refers to a specific instruction provided for a line of business (LOB), corporate function (Function), or other relevant party to execute the requirements of a policy, standard, or other business practice. Procedures delineate how to execute a task or process and are designed to ensure a process is followed in a consistent manner. An obligation is a legal requirement impacting the firm's businesses or functions. It summarizes the requirement(s) with which the firm must comply and describes what the firm must do or must not do to be in compliance with the identified legal requirement(s).

When any new obligation comes in the obligation library from the legal and regulatory feed, the application 602 generates and transmits at least one prompt for the new obligation to a framework 604 (also referred to as an orchestrator framework e.g., Langchain Frameworks®). It is to be noted that, for any new obligation, the application 602 searches for procedures in response to the new obligation from the database 606. The database 606 (also referred to as an office of legal obligations (OLO) vector database) includes historical mappings 608 (also referred to as historical office of legal obligations (OLO) mappings). More particularly, the historical mapping of internal procedures with the draft obligations are embedded in the database 606. As used herein, historical mapping 608 refers to the mapping of the existing procedures with the existing draft obligations. Further, the mapping of the existing procedures with the existing draft obligations may have been performed manually in the past. Further, the framework 604 is utilized to perform semantic search (also referred to as OLO semantic search) in the database 606 to identify the most relevant procedure(s) for the new obligation and fetch top search results or most relevant procedure(s). Further, the framework 604 sends the top search results to a large language model (LLM) environment 610. The LLM environment 610 includes an application programming interface (API) 612 communicably coupled with a hallucination filter 614, to evaluate search results. The API 612 may include ChatGPT® API or any other equivalent APIs. The API 612 filters out inaccurate or incomplete content from the top search results by using the hallucination filter 614. The hallucination filter 614 is used to filter out the top search results by removing any error in the results, by completing the existing incomplete sentences using natural language understanding, or by removing any other unwanted noise from the top search results. This way a final response is generated and transmitted back to the framework 604 by the LLM environment 610. Further, the framework 604 provides final mapping for the impacted procedures as per the new obligation, to the application 602. Thus, a user can view the final mappings for the impacted procedure on a user interface (UI) of the application 602. This way regulatory compliance is achieved.

The examples or use cases provided herein are for illustrative purposes only and should not be construed as limiting the scope of the invention. The invention is not limited to the specific examples described but encompasses all variations and embodiments that fall within the scope of the claims.

A first use case of the present disclosure relates to a procedure mapping, where the system (or RCMD 202) maps (e.g., process and subprocess mapping) at least one procedure from a bank procedure library to legal obligations to show compliance to regulatory requirements detailed by the obligation. The system also identifies specific sections of at least one procedure that address the obligation and generates comments to explain how these sections address the obligation.

A second use case of the present disclosure relates to a procedure compliance scenario after non-regulatory changes. The system ensures that the procedure mapped to obligations remains compliant with the legal requirements of the obligations even after procedure modifications due to business-driven changes and other non-regulatory procedure changes. Further, the system generates comments to explain how updated procedure sections address the obligation after each non-regulatory procedure change (e.g., draft issues).

A third use case of the present disclosure relates to procedure modifications. The system performs document uplift and document discrepancy remediation (DDR) for the creation of new procedures or modification of existing procedures to ensure compliance with legal requirements of the obligation (e.g., draft new procedures or modify existing procedures to meet legal requirements of the obligation).

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments that may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Therefore, the present disclosure provides a technical solution that provides efficient compliance of procedures of an organization with the latest regulations. Also, the present disclosure provides the technical solution that overcomes the limitations of the existing solutions such as including but not limited to the requirement of human resources at a large scale and manual errors while handling various tasks simultaneously. The present disclosure improves accuracy and data quality by impacting assessments, and procedure mapping, hence minimizing errors and mitigating risks. Further, the present disclosure is proactive as it performs a proactive assessment of any regulatory changes applicable to CB. Further, the present disclosure enhances operational efficiency by optimizing regulatory development, obligation and procedure drafting, and compliance assessments, thereby manual effort is reduced. The present disclosure helps in making accelerated and accurate data-driven decisions for legal and regulatory assessments and change management. The present disclosure helps to support re-evaluations of ever-changing legal and regulatory requirements. Further, the present disclosure provides a streamlined process that reduces search space for assessments and procedure mapping, making discussions with subject matter experts (SMEs) more effective. Moreover, the present disclosure provides a method and system that can be adapted to quickly evolve the regulatory landscape.

According to an aspect of the present disclosure, a non-transitory computer-readable storage medium storing instructions for regulatory compliance management is disclosed. The instructions include executable code which, when executed by a processor, may cause the processor to receive at least one regulatory document from at least one regulatory source; analyze, using a trained model, the at least one regulatory document; draft an obligation for at least one entity based on the analysis of the at least one regulatory document; map an information in the obligation to internal procedures and policies of the at least one entity; and update the internal procedures and policies of the at least one entity to maintain legal compliance with the obligation.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

We claim:

1. A method for regulatory compliance management, the method being implemented by at least one processor, the method comprising:
receiving, by the at least one processor, at least one regulatory document from at least one regulatory source;
analyzing, by the at least one processor using a trained model, the at least one regulatory document;
drafting, by the at least one processor, an obligation for at least one entity based on a result of the analyzing of the at least one regulatory document;
mapping, by the at least one processor, an information in the obligation to at least one from among a plurality of internal procedures and policies of the at least one entity; and
updating, by the at least one processor, the plurality of internal procedures and policies of the at least one entity to maintain a legal compliance with the obligation.

2. The method as claimed in claim 1, wherein the at least one regulatory document comprises a notification regarding at least one from among:
a change in at least one from among a law, a rule, and a regulation; and
a creation of at least one from among a new law, a new rule, and a new regulation.

3. The method as claimed in claim 1, wherein the trained model includes a large language model, which is trained using each of a set of legal data collected from a plurality of legal sources and a set of procedural data collected from a plurality of procedural sources.

4. The method as claimed in claim 1, wherein the mapping of the information in the obligation to the at least one from among the plurality of internal procedures and policies comprises:
identifying, by the at least one processor, at least one from among a plurality of impacted lines of business (LOB) and at least one from among a plurality of associated teams; and
mapping, by the at least one processor, the plurality of internal procedures and policies of the identified at least one impacted LOB with the obligation.

5. The method as claimed in claim 1, further comprising creating, by the at least one processor, at least one action plan for the at least one entity to resolve at least one control issue identified during the mapping of the information in the obligation to the at least one from among the plurality of internal procedures and policies, wherein the at least one action plan corresponds to at least one change to be performed to update the plurality of internal procedures and policies of the at least one entity to maintain the legal compliance with the obligation.

6. The method as claimed in claim 1, wherein the at least one entity corresponds to one from among an organization, a financial institution, a business entity, a firm, and a service provider.

7. The method as claimed in claim 1, wherein updating the plurality of internal procedures and policies to maintain the legal compliance with the obligation comprises one from among:
a modification of the plurality of internal procedures and policies; and
an addition of at least one from among a new procedure and a new policy.

8. A computing device configured to implement an execution of a method for regulatory compliance management, the computing device comprising:
a processor;
a memory; and
a communication interface coupled to each of the processor and the memory, wherein the processor is configured to:
receive at least one regulatory document from at least one regulatory source;
analyze, using a trained model, the at least one regulatory document;
draft an obligation for at least one entity based on the analysis of the at least one regulatory document;
map an information in the obligation to at least one from among a plurality of internal procedures and policies of the at least one entity; and
update the plurality of internal procedures and policies of the at least one entity to maintain a legal compliance with the obligation.

9. The computing device as claimed in claim 8, wherein the at least one regulatory document comprises a notification regarding at least one from among:
a change in at least one from among a law, a rule, and a regulation; and
a creation of at least one from among a new law, a new rule, and a new regulation.

10. The computing device as claimed in claim 8, wherein the trained model includes a large language model, which is trained using each of a set of legal data collected from a plurality of legal sources and a set of procedural data collected from a plurality of procedural sources.

11. The computing device as claimed in claim 8, wherein to map the information in the obligation to the at least one from among the plurality of internal procedures and policies, the processor is configured to:
identify at least one from among a plurality of impacted lines of business (LOB) and at least one from among a plurality of associated teams; and
map the plurality of internal procedures and policies of the identified at least one impacted LOB with the obligation.

12. The computing device as claimed in claim 8, wherein the processor is further configured to create at least one action plan for the at least one entity to resolve at least one control issue identified during the mapping of the information in the obligation to the at least one from among the plurality of internal procedures and policies, wherein the at least one action plan corresponds to at least one change to be performed to update the plurality of internal procedures and policies of the at least one entity to maintain the legal compliance with the obligation.

13. The computing device as claimed in claim 8, wherein the at least one entity corresponds to one from among an organization, a financial institution, a business entity, a firm, and a service provider.

14. The computing device as claimed in claim 8, wherein the update of the plurality of internal procedures and policies to maintain the legal compliance with the obligation comprises one from among:
a modification of the plurality of internal procedures and policies; and
an addition of at least one from among a new procedure and a new policy.

15. A non-transitory computer readable storage medium storing instructions for regulatory compliance management, the storage medium comprising executable code which, when executed by a processor, causes the processor to:
receive at least one regulatory document from at least one regulatory source;
analyze, using a trained model, the at least one regulatory document;
draft an obligation for at least one entity based on the analysis of the at least one regulatory document;
map an information in the obligation to at least one from among a plurality of internal procedures and policies of the at least one entity; and
update the plurality of internal procedures and policies of the at least one entity to maintain a legal compliance with the obligation.

16. The storage medium as claimed in claim 15, wherein the at least one regulatory document comprises a notification regarding at least one from among:
a change in at least one from among a law, a rule, and a regulation; and
a creation of at least one from among a new law, a new rule, and a new regulation.

17. The storage medium as claimed in claim 15, wherein the trained model includes a large language model, which is trained using each of a set of legal data collected from a plurality of legal sources and a set of procedural data collected from a plurality of procedural sources.

18. The storage medium as claimed in claim 15, wherein to map the information in the obligation to the at least one from among the plurality of internal procedures and policies, the processor is configured to:
identify at least one from among a plurality of impacted lines of business (LOB) and at least one from among a plurality of associated teams; and
map the plurality of internal procedures and policies of the identified at least one impacted LOB with the obligation.

19. The storage medium as claimed in claim 15, wherein the executable code when executed causes the processor to create at least one action plan for the at least one entity to resolve at least one control issue identified during the mapping of the information in the obligation to the at least one from among the plurality of internal procedures and policies, wherein the at least one action plan corresponds to at least one change to be performed to update the plurality of internal procedures and policies of the at least one entity to maintain the legal compliance with the obligation.

20. The storage medium as claimed in claim 15, wherein the update of the plurality of internal procedures and policies to maintain the legal compliance with the obligation comprises one from among:
a modification of the plurality of internal procedures and policies; and
an addition of at least one from among a new procedure and a new policy.
